(19) United States
(12) Patent Application Publication
(10) Pub. No.: US 2002/0089916 A1
(43) Pub. Date: Jul. 11, 2002

(54) SUSPENSION ARM ACTUATOR

(76) Inventors: HSIAO-WEN LEE, HSINCHU (TW); LI-DING WEI, TAIPEI (TW)

Correspondence Address: J.C. PATENTS INC., 4 VENTURE, SUITE 250, IRVINE, CA, 92618, US

(21) Appl. No.: 09/474,995

(22) Filed: Dec. 30, 1999

(30) Foreign Application Priority Data
Nov. 9, 1999 (TW) 88119553

(51) Int. Cl. G11B 17/30; G11B 21/02; G11B 17/00; G11B 21/16

(52) U.S. Cl. 369/222; 369/244

(57) ABSTRACT

An optical read/write head of an optical data storage/retrieval device is supported by a suspension arm actuator. The suspension arm actuator has a suspension arm element on which a plurality of electrode layers and a plurality of piezoelectric films are sequentially stacked on top of one another. The electrode layers have specific electrical states which induce a deformation of the suspension arm actuator.

### CROSS-REFERENCE TO RELATED APPLICATION

This application claims the priority benefit of Taiwan application serial no. 88119553, filed Nov. 9, 1999.

### BACKGROUND OF THE INVENTION

1. Field of the Invention

The present invention relates to a suspension arm actuator. More particularly, the present invention relates to a suspension arm actuator for an objective lens of an optical read/write head.

2. Description of the Prior Art

A typical optical data storage/retrieval device such as a compact disk-read only memory (CD-ROM) player, or digital versatile disk (DVD) player can retrieve a large amount of data stored on an optical disc. As multi-media technology progresses, employing optical discs for a large amount of video/audio data storage is becoming increasingly popular. Moreover, the development of the DVD technology has pushed the total storage memory available in an optical disc from 650 MB on a conventional CD-ROM to 4.7 GB. The total storage memory of a DVD may even further increase up to 15 GB in the near future.

An optical data storage/retrieval device has an optical read/write head. A laser light beam is emitted from a light source. By means of an objective lens, the laser light beam is then focused on an optical disc. The laser light beam passes through a substrate of the optical disc, and forms a light spot on an information layer. A reflection of the laser light beam from the information layer is received by the optical read/write head. Hence, information stored in the optical disc is retrieved.

When total storage volume and density of information in an optical disc is progressively increased, a numerical aperture (NA) of an objective lens has to be increased, as well. This reduces a working distance of the objective lens, and hence, a more precise servo-actuator for focusing the objective lens is required. Similar problems occur when the size of an optical read/write head and/or an objective lens is reduced. Such effects are more prominence in near-field optics. However, a typical design of the optical read/write head employs a voice-coil motor actuator. When the total storage volume and density of information in an optical disc is further increased, such design cannot satisfy a precision requirement. Therefore, how to amend problems which arise from the situations described above, and compensate for deviations due to a vertical trembling of a rotating optical disc, are currently main issues today.

Accordingly, in order to amend problems which arise from an increase in total storage volume and density of information in an optical disc, and to compensate for deviations due to a vertical trembling of a rotating optical disc, different servo-methods for a focus of an objective lens, and servo-control actuators have been developed. For example, a flying-head design for a disc player has been introduced. Reference is made to FIGS. 1A and 1B, which are respectively top and side views showing the structure of a prior art flying-optical head.

As shown in FIGS. 1A and 1B, a flying-optical head 100 is supported by a suspension arm 102. When an optical disc 108 is rotated by a spindle motor (not shown), an air-stream is formed by towing the surrounding air. Buoyancy of the flying-optical head 100 is induced by the air-stream, and the flying-optical head 100 is lifted up to a desired height. By employing such method just mentioned, a sliding element 106 has to be disposed under an objective lens 104 of the flying-optical head 100. An optimization design for the sliding element 106 is required, as well. Therefore, by means of an air pad, which is formed during the rotation of the optical disc 108, a desired distance between the flying-optical head 100 and the optical disc 108 is maintained. A servo-operation for the focus of the objective lens 104 is then established.

However, there are two main drawbacks of the method described above. One is that when the optical disc 108 is not in motion, the flying-optical head 100 is parked on a surface of the optical disc 108. In order to prevent a scraping and collision between the flying-optical head 100 and the optical disc 108 during a lift-off from or landing on the optical disc 108, a protective lubricant film 110, such as the one disclosed in the U.S. Pat. No. 5,202,880, is coated on the optical disc 108.

Another drawback is that a thickness of the air pad, and hence, the buoyancy of the flying-optical head, formed during the rotation of the optical disc 108 are related to a Reynolds number (Re) and a shape of the sliding element 106. Therefore, different optimized designs of the sliding element 106 have to be considered for optical disc players with different operating speeds. Therein, the Reynolds number is obtained by multiplying a density of a fluid by a flow speed and a feature length, and then divided by a viscosity of the fluid.

### SUMMARY OF THE INVENTION

Accordingly, the present invention provides a suspension arm actuator which is employed to support an optical read/write head of an optical data storage/retrieval device. The suspension arm actuator comprises a suspension arm element, piezoelectric films, and electrode layers disposed on surfaces of the piezoelectric films. A conventional optical read/write head is employed, and no additional elements and actuators are required. A piezoelectric film technology is employed to construct a piezoelectric suspension arm actuator. A desired distance between a flying-optical head and an optical disc is maintained by the piezoelectric suspension arm actuator. There is no direct contact between the flying-optical head and the optical disc. Therefore, a scraping and collision between the flying-optical head and the optical disc is prevented. This also prevents damage of a protective lubricant film coated on the optical disc. Moreover, the distance between the flying-optical head and the optical disc is under active control. No optimization of a shape of a sliding element is required when the flying-optical head is applied to different operating speed disc players.

To achieve these objects and other advantages and in accordance with the purpose of the present invention, a suspension arm actuator is disclosed herein, which includes a suspension arm element for supporting an optical read/write head of an optical data storage/retrieval device. A piezoelectric film is disposed on a surface of the suspension arm element. Electrode layers with specific layout patterns are disposed on top and bottom surfaces of the piezoelectric film. An adjustment of electrical states of the electrode layers on the surfaces of the piezoelectric film induces a deformation of the piezoelectric film. Hence, the suspension arm element is deformed, as well. This compensates for problems which arise from an increased total storage volume and density of information in an optical disc, and compensates for deviations due to a vertical trembling of a rotating optical disc, as well. Moreover, a distance between the flying-optical head and the optical disc is under active control. Scraping and collision between the flying-optical head and the optical disc is prevented. This also prevents damage of a protective lubricant film coated on the optical disc, and is applicable to disc players having different operating speeds. It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the present invention, and are incorporated in and constitute a part of this specification. The drawings illustrate preferred embodiments of the present invention and, together with the description, serve to explain the principles of the present invention. In the drawings,

FIGS. 1A and 1B are top and side views showing structure of a prior art flying-optical head, respectively;

FIG. 2 is a schematic, perspective view showing a deformation of a piezoelectric material due to an externally applied electrical field;

FIG. 3 is a side view showing structure of a flying-optical head with a suspension arm actuator in accordance with a preferred embodiment of the present invention;

FIGS. 4A and 4B are cross-sectional views of a suspension arm actuator in accordance with a preferred embodiment of the present invention without and with an externally applied electrical field, respectively;

FIG. 5 is a schematic view showing structure of an optical read/write head in accordance with a preferred embodiment of the present invention;

FIG. 6A is a cross-sectional view of a suspension arm actuator in accordance with a preferred embodiment of the present invention;

FIG. 6B is a cross-sectional view of another suspension arm actuator in accordance with a preferred embodiment of the present invention;

FIG. 7 is a schematic view showing operating modes of a flying-optical head with a suspension arm actuator in accordance with a preferred embodiment of the present invention;

FIGS. 8A and 8B are graphs illustrating the first structural mode and the second structural mode of a piezoelectric suspension arm actuator in accordance with a preferred embodiment of the present invention, respectively;

FIG. 8C is a graph illustrating the structural mode of a piezoelectric suspension arm actuator in accordance with a preferred embodiment of the present invention by superpositioning the first and the second structural modes; and

FIGS. 9A and 9B are graphs illustrating electrical states of electrode layers which result the first structural mode and the second structural mode of a piezoelectric suspension arm actuator in accordance with a preferred embodiment of the present invention, respectively.

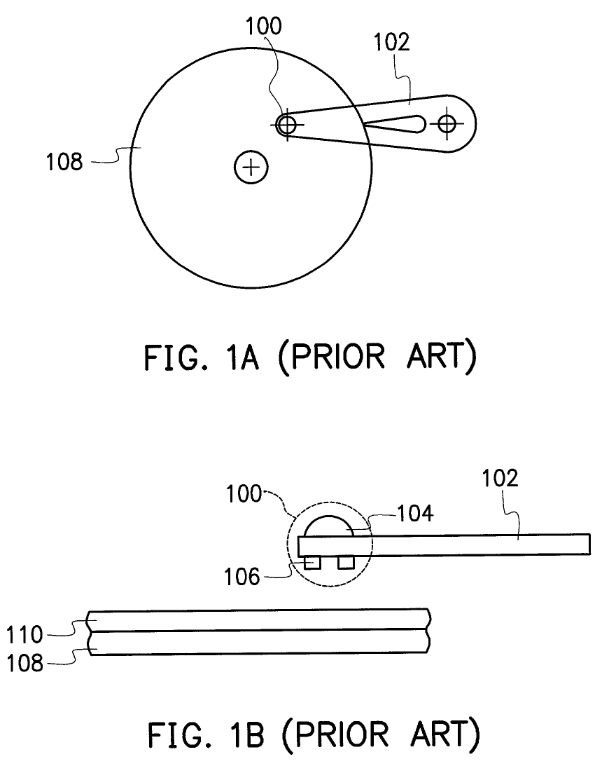

### DESCRIPTION OF THE PREFERRED EMBODIMENTS

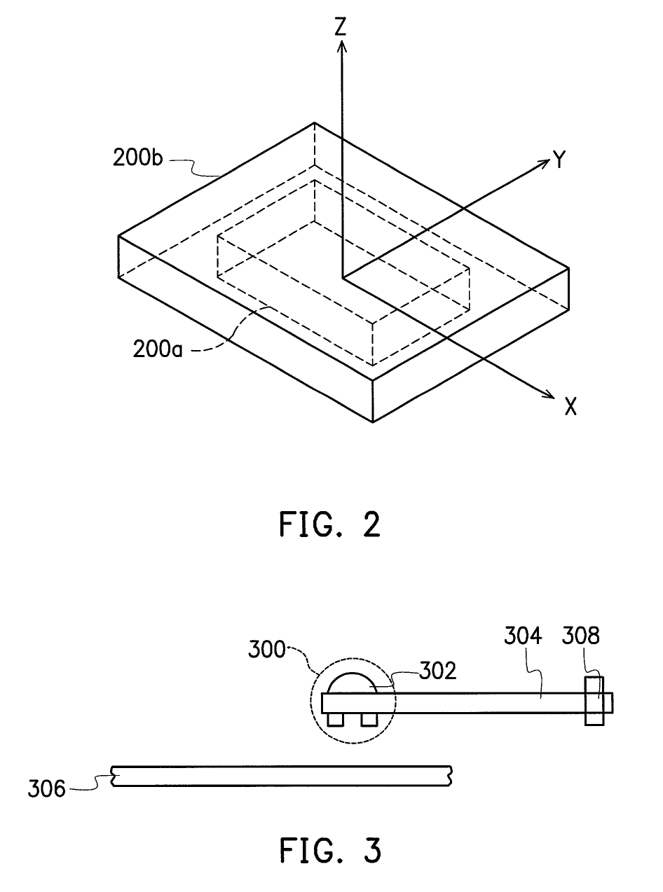

Piezoelectric materials process an electrical-mechanical energy interchange characteristic. When an external electrical field is applied to a piezoelectric material, for example, deformation of the piezoelectric material occurs due to induced mechanical stresses. Reference is made to FIG. 2, which is a schematic, perspective view showing deformation of a piezoelectric material due to an externally applied electrical field. Coordinate axes x, y, and z are shown for reference. Dotted lines indicate an original shape of a piezoelectric film 200a before an external electrical field is applied. When an external electrical field is applied along the z-axis, deformation of the piezoelectric film occurs. For example, in the present of the external electrical field applied along the z-axis, the piezoelectric film extends in the x, y, and z directions, and results in a shape indicated by solid lines 200b as shown in FIG. 2. Hence, if the piezoelectric film is adhered to a structural element, the externally applied electrical field will induce a deformation of that structural element, as well. By adjusting electrical states of electrode layers disposed on the piezoelectric film or varying the externally applied electrical field, the structural element can be deformed in a desired structural mode according to a design requirement.

A suspension arm actuator, which supports a flying-optical head, can be considered as a cantilever plate in a structural analysis. Therefore, a structural design and construction of the present invention is established by applying the piezoelectric plate theory. A suspension arm actuator according to the present invention comprises an adhesion of piezoelectric films on a suspension arm element. Reference is made to FIG. 3, which is a side view showing the structure of a flying-optical head with a suspension arm actuator in accordance with a preferred embodiment of the present invention. A flying-optical head 300 of FIG. 3 includes an objective lens 302. A suspension arm actuator 304 is employed to support the flying-optical head 300. Data can be read from or written to a disc 306 through the flying-optical head. The suspension arm actuator 304, which is secured by a fixed end 308, includes a suspension arm element, piezoelectric films, electrode layers disposed on surfaces of the piezoelectric films, etc.

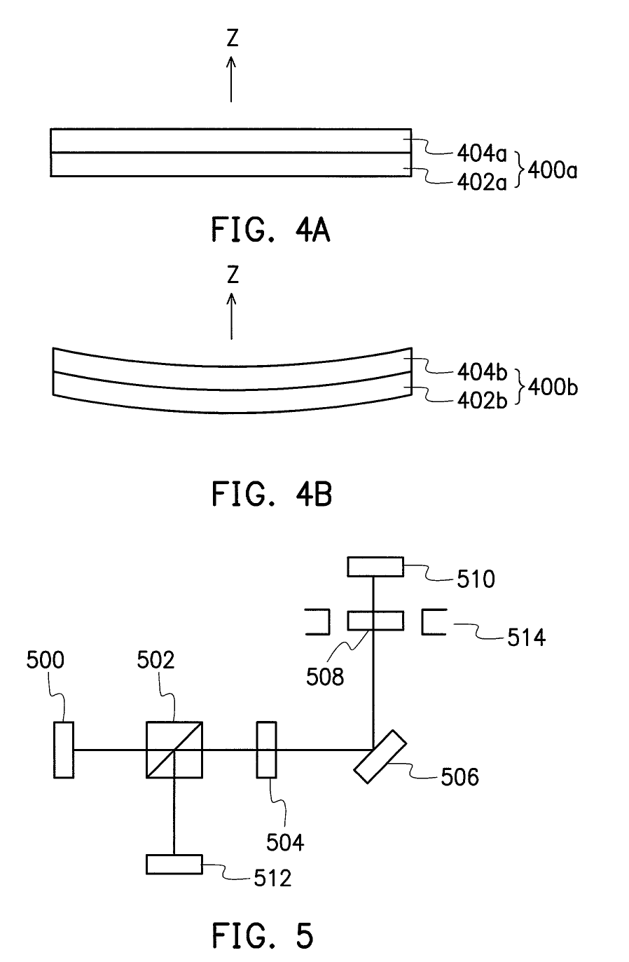

Reference is made to FIGS. 4A and 4B, which illustrate cross-sectional views of a suspension arm actuator in accordance with a preferred embodiment of the present invention without and with an externally applied electrical field, respectively. It is noted that a piezoelectric suspension arm actuator 400a of FIG. 4A, and 400b of FIG. 4B, is just the suspension arm actuator 304 of FIG. 3. The piezoelectric suspension arm actuator 400a includes a suspension arm element 402a and a piezoelectric film 404a. The piezoelectric film 404a is adhered on a surface of the suspension arm element 402a and perfect bonding is assumed. Without an externally applied electrical field, the piezoelectric suspension arm actuator 400a is in a level position as shown in FIG. 4A.

When an external electrical field is applied, for example, along the z-axis, a suspension arm element 402b of FIG. 4B is deformed due to a deformation of a piezoelectric film 404b. Hence, the piezoelectric suspension arm actuator 400b can be deformed in a controlled manner by varying the externally applied electrical field. Therefore, a distance between the flying-optical head and an optical disc, and even a focus position of the objective lens, can be controlled. The piezoelectric film shown in FIGS. 4A and 4B includes a PZT ceramic film, or a polyvinylidene fluoride (PVDF) composite film.

Reference is made to FIG. 5, which is a schematic view showing structure of an optical read/write head in accordance with a preferred embodiment of the present invention. A laser light beam is emitted from a light source 500. After passing through a splitter 502, the light beam is directed to a collimator 504. After a correction of the light beam by the collimator 504, a reflector 506 is employed to reflect the light beam to an objective lens 508. The light beam is then focus on an optical disc 510 by the objective lens 508, and data can be read from or written to the optical disc 510. The light source 500 includes a 650 nm laser diode or a 780 nm laser diode. The optical disc 510 can be a conventional CD, VCD, DVD, etc. A reflected light beam from the optical disc 510 passes through the objective lens 508, and is reflected by the reflector 506, corrected by the collimator 504, reflected by the splitter 502, and finally received by a photodetector 512. Moreover, a piezoelectric suspension arm actuator 514 is included, which supports the optical read/write head. The piezoelectric suspension arm actuator 514 is employed to control a distance between the objective lens 508 and the optical disc 510, and as a servo-control for the focus of the objective lens 508.

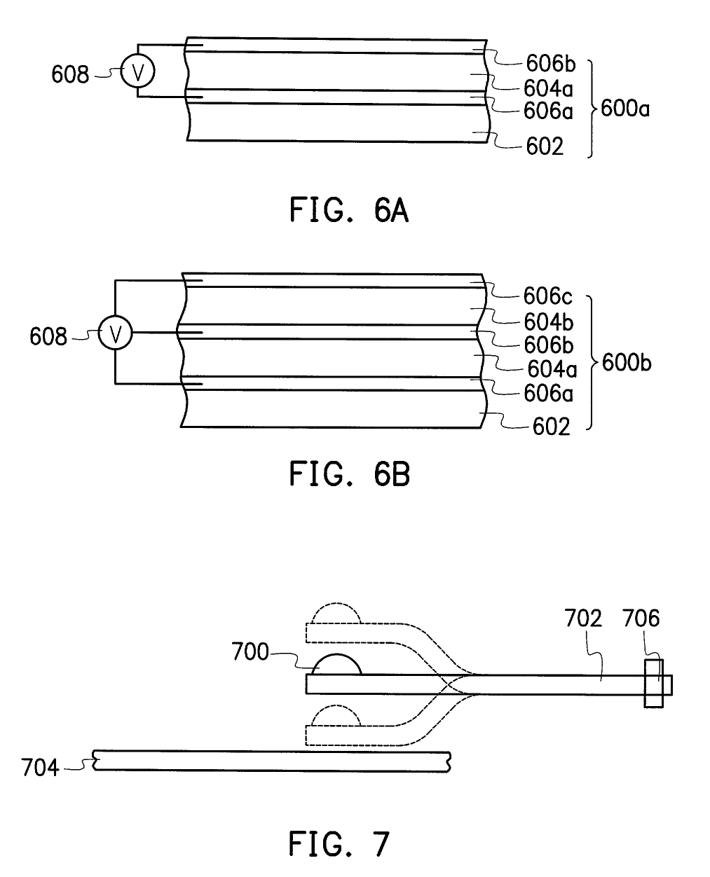

Reference is made to FIG. 6A, which illustrates a cross-sectional view of a suspension arm actuator in accordance with a preferred embodiment of the present invention. It is noted that a suspension arm actuator 600a of FIG. 6A is just the suspension arm actuator 304 of FIG. 3. A suspension arm element 602 has a cantilever plate characteristic in a structural analysis just as the suspension arm element 402a and 402b of FIGS. 4A and 4B, respectively. As shown in FIG. 6A, a first electrode layer 606a is adhered on a surface of the suspension arm element 602. A piezoelectric film 604a is then disposed on a surface of the first electrode layer 606a and perfect bonding is assumed. The first electrode layer 606a lies between the suspension arm element 602 and the piezoelectric film 604a. A second electrode layer 606b is adhered on a surface of the piezoelectric film 604a such that the piezoelectric film 604a lies between the first electrode layer 606a and the second electrode layer 606b. A material of the piezoelectric film 604a is the same as the piezoelectric film 404a of FIG. 4A and 404b of FIG. 4B, such as PZT or PVDF. In addition, the first electrode layer 606a and the second electrode layer 606b are electrically connected to an external power supply 608.

Reference is made to FIG. 6B, which illustrates a cross-sectional view of another suspension arm actuator in accordance with a preferred embodiment of the present invention. A suspension arm actuator 600b of FIG. 6B is just the suspension arm actuator 304 of FIG. 3. A plurality of electrode layers and a plurality of piezoelectric films are disposed on a surface of a suspension arm element 602, which has a cantilever plate characteristic in a structural analysis, such that the electrode layers and the piezoelectric films are stacked on top of one another. As shown in FIG. 6B, a first electrode layer 606a, a first piezoelectric film 604a, a second electrode layer 606b, a second piezoelectric film 604b, and a third electrode layer 606c are sequentially stacked on the surface of the suspension arm element 602. Materials of the piezoelectric films 604a and 604b include PZT and PVDF. Moreover, the electrode layers 606a, 606b, and 606c are electrically connected to an external power supply 608.

The suspension arm actuator 600b described above, which is constructed by sequentially stacking a first electrode layer 606a, a first piezoelectric film 604a, a second electrode layer 606b, a second piezoelectric film 604b, and a third electrode layer 606c on the surface of the suspension arm element 602, is exemplary, and is intended to provide further explanation of the present invention. It is not intended to limit the present invention in any ways. Other numbers of electrode layers and piezoelectric films can be stacked on the suspension arm element 602 to compensate for any deviations due to a vertical trembling of a rotating disc, and to control a distance between a flying-optical head and a disc.

Reference is made to FIG. 7, which is a schematic view showing operating modes of a flying-optical head with a suspension arm actuator in accordance with a preferred embodiment of the present invention. As shown in FIG. 7, which is similar to what is shown in FIG. 3, a flying-optical head 700 is supported by a piezoelectric suspension arm actuator 702. Data can be read from or written to a disc 704. The piezoelectric suspension arm actuator 702 is secured by a fixed end 706. A tilt angle of the flying-optical head 700 has to be zero or very small.

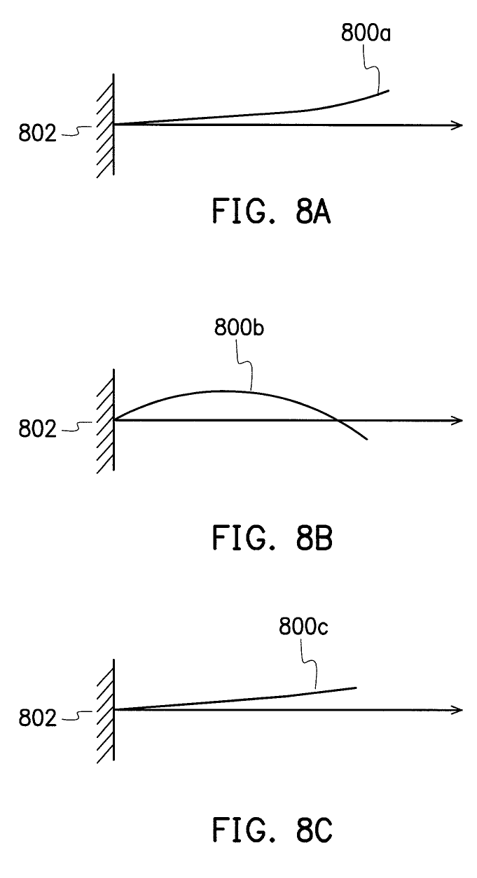

Because the piezoelectric suspension arm actuator of the present invention can be analyzed as a cantilever plate, analysis of structural modes of the piezoelectric suspension arm actuator are shown in FIGS. 8A to 8C (item 802 indicates a fixed end). Reference is made to FIG. 8A and 8B, which are graphs illustrating the first structural mode and the second structural mode of a piezoelectric suspension arm actuator in accordance with a preferred embodiment of the present invention, respectively. FIG. 8C is a graph illustrating the structural mode of a piezoelectric suspension arm actuator in accordance with a preferred embodiment of the present invention by superpositioning the first and the second structural modes. Therefore, by means of a deformation of piezoelectric films and the principle of superposition, the piezoelectric suspension arm actuators 800a, 800b, and 800c are deformed in such a way that a tilt angle of a flying-optical head is zero or within an allowable limit. A desired distance between the flying-optical head and a disc is maintained, as well.

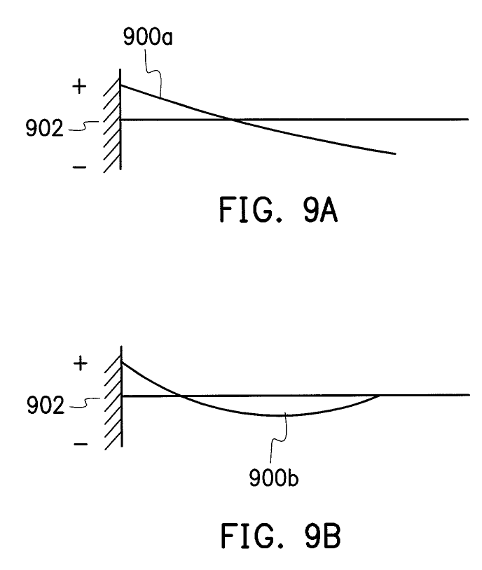

In order to have a desired operating mode of a piezoelectric suspension arm actuator after an external electrical voltage is applied, more than one piezoelectric film can be employed. With corresponding specific pattern layout of electrode layers, specific structural modes, or superpositioned structural modes by means of the superposition principle, can be obtained. A desired tilt angle of a flying-optical head can be maintained. FIGS. 9A and 9B are graphs illustrating electrical states of electrode layers which result in the first structural mode and the second structural mode of a piezoelectric suspension arm actuator in accordance with a preferred embodiment of the present invention, respectively.

According to FIGS. 9A and 9B (item 902 indicates a fixed end), with reference to FIGS. 8A to 8C, electrical states (items 900a and 900b) of electrode layers are applied to piezoelectric films. A desired deformation of a piezoelectric suspension arm actuator can then be obtained, which deformation compensates for deviations due to a vertical trembling of a rotating disc, and a distance between a flying-optical head and a disc is under actively controlled. According to the present invention, when a more precise dynamic control of the piezoelectric suspension arm actuator is required, higher structural modes resulting in a structural dynamic analysis can be introduced. Corresponding piezoelectric films and electrode layers having specific pattern layouts are stacked on a surface of a suspension arm element, which gives a more precise control of a dynamic motion of the piezoelectric suspension arm actuator.

A manufacturing process for a piezoelectric suspension arm actuator of the present invention involves adhering a plurality of PVDF composite films or PZT ceramic films, for example, on a typical suspension arm structure. Alternatively, piezoelectric films are coated directly on a surface of a suspension arm element. The piezoelectric suspension arm actuator of the present invention is suitable for a number of optical data storage/retrieval devices such as an optical disc player. An example of use is the support of an optical read/write head of an optical disc player. Moreover, the piezoelectric suspension arm actuator 304 of FIG. 3 can be employed in a near-field optical disc player for supporting a flying-optical head, as an example.

In a prior art technique, by means of an air pad which arises during a rotation of an optical disc, the focus of an objective lens for a near-field flying-optical head is under a servo-control. Scraping and collision between the flying-optical head and the optical disc may occur, which damages the flying-optical head. Based on the foregoing, a piezoelectric suspension arm actuator in accordance with a preferred embodiment of the present invention is constructed by stacking electrode layers and piezoelectric films on a surface of a suspension arm element. By applying an external electrical field, the motion of the piezoelectric suspension arm actuator is actively controlled. A distance between the flying-optical head and the optical disc, and a tilt angle of the flying-optical head are maintained. Deviations due to a vertical trembling of the rotating optical disc can be compensated for, as well. Therefore, the piezoelectric suspension arm actuator of the present invention can prevent damage of the flying-optical head, and make the flying-optical head adaptable to optical disc players with different operating speeds.

While the present invention has been disclosed with reference to the preferred embodiments described above, it is not intended to limit the present invention in any way. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A suspension arm actuator, comprising:
a suspension arm element;
a first electrode layer disposed on a surface of the suspension arm element;
a piezoelectric film disposed on a surface of the first electrode layer such that the first electrode layer lies between the suspension arm element and the piezoelectric film; and
a second electrode layer disposed on a surface of the piezoelectric film such that the piezoelectric film lies between the first electrode layer and the second electrode layer.

2. The suspension arm actuator of claim 1, wherein a material of the piezoelectric film includes PZT.

3. The suspension arm actuator of claim 1, wherein a material of the piezoelectric film includes polyvinylidene fluoride (PVDF).

4. A suspension arm actuator, comprising:
a suspension arm element;
a plurality of electrode layers disposed on top of the suspension arm element; and
a plurality of piezoelectric films disposed on top of the suspension arm element such that the piezoelectric films and the electrode layers are stacked on top of one another, with the piezoelectric films disposed between every two adjacent electrode layers.

5. The suspension arm actuator of claim 4, wherein materials of the piezoelectric films include PZT.

6. The suspension arm actuator of claim 4, wherein materials of the piezoelectric films include polyvinylidene fluoride (PVDF).

7. An objective lens actuator for a read/write head of a data storage/retrieval device, which data storage/retrieval device includes an optical disc player, comprising:
a suspension arm element;
a first electrode layer disposed on a surface of the suspension arm element;
a piezoelectric film disposed on a surface of the first electrode layer such that the first electrode layer lies between the suspension arm element and the piezoelectric film; and
a second electrode layer disposed on a surface of the piezoelectric film such that the piezoelectric film lies between the first electrode layer and the second electrode layer.

8. The objective lens actuator of claim 7, wherein a material of the piezoelectric film includes PZT.

9. The objective lens actuator of claim 7, wherein a material of the piezoelectric film includes polyvinylidene fluoride (PVDF).

10. An objective lens actuator for a read/write head of a data storage/retrieval device, which data storage/retrieval device includes an optical disc player, comprising:
a suspension arm element;
a plurality of electrode layers disposed on top of the suspension arm element; and
a plurality of piezoelectric films disposed on top of the suspension arm element such that the piezoelectric films and the electrode layers are stacked on top of one another, with the piezoelectric films disposed between every two adjacent electrode layers.

11. The objective lens actuator of claim 10, wherein materials of the piezoelectric films include PZT.

12. The objective lens actuator of claim 10, wherein materials of the piezoelectric films include polyvinylidene fluoride (PVDF).

13. An optical read/write head, comprising:
a light source;
a splitter optically coupled with the light source, wherein the splitter receives a light beam emitted by the light source;
a collimator optically coupled with the splitter, wherein the collimator receives the light beam which passes through the splitter;
a reflector optically coupled with the collimator, wherein the reflector reflects the light beam which passes through the collimator;
an objective lens optically coupled with the reflector, wherein the objective lens focuses the light beam reflected by the reflector onto an optical disc;
an objective lens actuator coupled with the objective lens, wherein the objective lens actuator is employed to control a distance between the objective lens and the optical disc, and as a servo-control for focusing the objective lens, the objective lens actuator further comprising:
a suspension arm element;
a first electrode layer disposed on a surface of the suspension arm element;
a piezoelectric film disposed on a surface of the first electrode layer such that the first electrode layer lies between the suspension arm element and the piezoelectric film; and
a second electrode layer disposed on a surface of the piezoelectric film such that the piezoelectric film lies between the first electrode layer and the second electrode layer; and
a photodetector optically coupled with the splitter, wherein the photodetector receives a light beam which is reflected from the optical disc, passes through the objective lens, is reflected by the reflector, passes through the collimator, and is reflected by the splitter.

14. The optical read/write head of claim 13, wherein a material of the piezoelectric film includes PZT.

15. The optical read/write head of claim 13, wherein a material of the piezoelectric film includes polyvinylidene fluoride (PVDF).

16. An optical read/write head, comprising:
a light source;
a splitter optically coupled with the light source, wherein the splitter receives a light beam emitted by the light source;
a collimator optically coupled with the splitter, wherein the collimator receives the light beam which passes through the splitter;
a reflector optically coupled with the collimator, wherein the reflector reflects the light beam which passes through the collimator;
an objective lens optically coupled with the reflector, wherein the objective lens focuses the light beam reflected by the reflector onto an optical disc;
an objective lens actuator coupled with the objective lens, wherein the objective lens actuator is employed to control a distance between the objective lens and the optical disc, and as a servo-control for focusing the objective lens, the objective lens actuator further comprising:
a suspension arm element;
a plurality of electrode layers disposed on top of the suspension arm element; and
a plurality of piezoelectric films disposed on top of the suspension arm element such that the piezoelectric films and the electrode layers are stacked on top of one another, with the piezoelectric films disposed between every two adjacent electrode layers; and
a photodetector optically coupled with the splitter, wherein the photodetector receives a light beam which is reflected from the optical disc, passes through the objective lens, is reflected by the reflector, passes through the collimator, and is reflected by the splitter.

17. The optical read/write head of claim 16, wherein materials of the piezoelectric films include PZT.

18. The optical read/write head of claim 16, wherein materials of the piezoelectric films include polyvinylidene fluoride (PVDF).
